(19) United States
(12) Patent Application Publication
(10) Pub. No.: US 2026/0329766 A1
(43) Pub. Date: Oct. 22, 2026

(54) OPTIMAL SET INDEXING OF MULTIPLE PAGE SIZES IN A SET ASSOCIATIVE TRANSLATION LOOKASIDE BUFFER

(71) Applicant: Apple Inc., Cupertino, CA (US)

(72) Inventors: Roy G. MOSS, Cupertino, CA (US); Seungjin LEE, Los Altos, CA (US); Kenneth W. WATERS, San Jose, CA (US)

(73) Assignee: Apple Inc., Cupertino, CA (US)

(21) Appl. No.: 19/181,438

(22) Filed: Apr. 17, 2025

(51) Int. Cl. G06F 12/02

(52) U.S. Cl. CPC G06F 12/0292; G06F 2212/1028

(57) ABSTRACT

Disclosed herein are systems and methods for indexing multiple page sizes in a set associative TLB. For example, a TLB includes tag memory devices configured to store virtual addresses for pages of a first size and a second size, respectively, and a data memory device configured to store physical addresses of the pages of both sizes. The TLB receives a translation request to translate a virtual address to a physical address. The TLB provides, based on the request, lookup requests comprising portions of the virtual address to the tag memory devices. The TLB determines that one of the portions of the virtual address is stored in one of the tag memory devices. The TLB obtains the physical address of the page from the data memory device based on a determination that that one of the portions of the virtual address is stored in one of the tag memory devices.

### BACKGROUND

Address translation is used for a variety of reasons. For example, address translation can be used to provide a larger effective or virtual address space than the amount of physical memory included in the computer system. Page tables may be provided in system memory, which store the virtual-to-physical translation mappings for pages stored in system memory. Accordingly, an address translation includes one or more memory accesses to read the translation from the page tables. To expedite the translation mechanism, many processors implement translation lookaside buffers (TLBs), which are caches of recently-used translations. However, indexing different page sizes with a TLB is computationally expensive, as the indexing method utilized for one page is suboptimal for another page size. One solution is to utilize multiple TLBs, one for each page size. However, this unnecessarily increases the size of an integrated circuit (IC) in which multiple TLBs are implemented, as well as the power requirements of the IC.

### SUMMARY

Various embodiments for indexing multiple page sizes in a set associative translation lookaside buffer are disclosed. In some embodiments, a system includes at least one processor configured to provide a translation request to translate a virtual address of a page to a physical address of the page and a translation lookaside buffer. The translation lookaside buffer includes a first tag memory device configured to store first virtual addresses of first pages of a first size, a second tag memory device configured to store second virtual addresses of second pages of a second size, and a data memory device configured to store physical addresses of the first pages and the second pages. The translation lookaside buffer is configured to provide, based on the translation request, a first lookup request including a first portion of the virtual address to the first tag memory device and a second lookup request including a second portion of the virtual address to the second tag memory device. The translation lookaside buffer is also configured to determine that the first portion of the virtual address is stored in the first tag memory device or the second portion of the virtual address is stored in the second tag memory device based on provision of the first lookup request and the second lookup request. The translation lookaside buffer is further configured to obtain the physical address of the page from the data memory device based on a determination that the first portion of the virtual address is stored in the first tag memory device or the second portion of the virtual address is stored in the second tag memory device. The translation lookaside buffer is also configured to provide the physical address to the processor for retrieval of the page based on the physical address.

In some embodiments, a method includes receiving, by a translation lookaside buffer, a translation request to translate a virtual address of a page to a physical address of the page, where the translation lookaside buffer includes a first tag memory device configured to store first virtual addresses of first pages of a first size, a second tag memory device configured to store second virtual addresses of second pages of a second size, and a data memory device configured to store physical addresses of the first pages and the second pages. The method also includes providing, based on the translation request, a first lookup request including a first portion of the virtual address to the first tag memory device and a second lookup request including a second portion of the virtual address to the second tag memory device. The method further includes determining that the first portion of the virtual address is stored in the first tag memory device or the second portion of the virtual address is stored in the second tag memory device based on providing the first lookup request and the second lookup request. The method also includes obtaining the physical address of the page from the data memory device based on determining that the first portion of the virtual address is stored in the first tag memory device or the second portion of the virtual address is stored in the second tag memory device. The method further includes obtaining the page from system memory based on the physical address.

In some embodiments, a device includes a translation lookaside buffer. The translation lookaside buffer includes a first tag memory device configured to store first virtual addresses of first pages of a first size, a second tag memory device configured to store second virtual addresses of second pages of a second size, and a data memory device configured to store physical addresses of the first pages and the second pages. The translation lookaside buffer is configured to receive a translation request to translate a virtual address of a page to a physical address of the page. The translation lookaside buffer is also configured to provide, based on the translation request, a first lookup request including a first portion of the virtual address to the first tag memory device and a second lookup request including a second portion of the virtual address to the second tag memory device. The translation lookaside buffer is further configured to determine that the first portion of the virtual address is stored in the first tag memory device or the second portion of the virtual address is stored in the second tag memory device based on provision of the first lookup request and the second lookup request. The translation lookaside buffer is also configured to obtain the physical address of the page from the data memory device based on a determination that the first portion of the virtual address is stored in the first tag memory device or the second portion of the virtual address is stored in the second tag memory device.

### BRIEF DESCRIPTION OF THE DRAWINGS

The accompanying drawings are incorporated herein and form a part of the specification.

FIG. 1 is a high-level diagram of an electronic device, according to some embodiments.

FIG. 2 is a block diagram illustrating components in the electronic device, according to some embodiments.

FIG. 3 is a block diagram illustrating a neural processor, according to some embodiments.

FIG. 4 is a block diagram of a neural engine of the neural processor, according to some embodiments.

FIG. 5 is a block diagram of a system configured to perform virtual-to-physical address translations, according to some embodiments.

FIG. 6 is a block diagram of a first tag memory device, according to some embodiments.

FIG. 7 is a block diagram of a second tag memory device, according to some embodiments.

FIG. 8A is a block diagram of a data memory device, according to some embodiments.

FIG. 8B is a block diagram of a data memory device, according to some embodiments.

FIG. 9 is a flowchart for a method for performing a virtual-to-physical address translation based on a data memory configured to store one page table entry per way, according to some embodiments.

FIG. 10 is a flowchart for a method for performing a virtual-to-physical address translation based on a data memory configured to store two page table entries per way, according to some embodiments.

FIG. 11 is a flowchart for a method for performing virtual-to-physical address translations, according to some embodiments.

FIG. 12 is a flowchart for a method for determining that a portion of a virtual address is stored in a first tag memory device or a second tag memory device, according to some embodiments

FIG. 13 is an example computer system that can be used for implementing some aspects or portion(s) thereof.

In the drawings, like reference numbers generally indicate identical or similar elements. Additionally, generally, the left-most digit(s) of a reference number identifies the drawing in which the reference number first appears.

### DETAILED DESCRIPTION

One way of indexing a set associative translation lookaside buffer (TLB) is using the least significant bits of the page number. For TLBs that support multiple page sizes, this has been a dilemma because the optimal indexing method for one page size is suboptimal for another page size. One solution is to use different TLBs for different page sizes. However, this is wasteful if one page size is utilized more frequently than another page size. Another solution is to perform a physical address lookup for each page serially, but this tends to favor the page size looked up first, thereby resulting in the retrieval of a suboptimal page size. The embodiments described herein achieves optimal indexing by utilizing a TLB including separate tag memories for each page size, but a single data memory that is shared between all page sizes. The tag memories are read in parallel, each with the optimal page index (e.g., corresponding to a particular set of bits of the virtual address). Such embodiments advantageously minimize the amount of memory required to maintain virtual-to-physical translations for pages of a different size.

For instance, provided herein are a system, apparatus, device, method and/or computer program product embodiments, and/or combinations and sub-combinations thereof, for indexing multiple page sizes in a set associative TLB. For example, a TLB may include a first tag memory device configured to store first virtual addresses of first pages of a first size, a second tag memory device configured to store second virtual addresses of second pages of a second size, and a data memory device configured to store physical addresses of the first pages and the second pages. The TLB may receive a translation request to translate a virtual address of a page to a physical address of the page. The TLB may also provide, based on the translation request, a first lookup request including a first portion of the virtual address to the first tag memory device and a second lookup request including a second portion of the virtual address to the second tag memory device. The TLB may further determine that the first portion of the virtual address is stored in the first tag memory device or the second portion of the virtual address is stored in the second tag memory device based on provision of the first lookup request and the second lookup request. The TLB may also obtain the physical address of the page from the data memory device based on a determination that the first portion of the virtual address is stored in the first tag memory device or the second portion of the virtual address is stored in the second tag memory device.

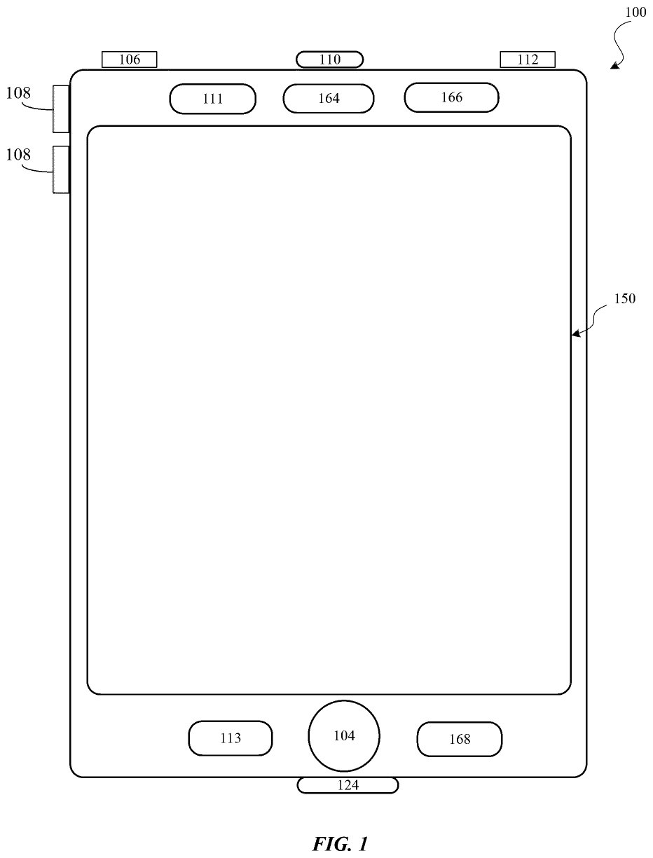

Embodiments of electronic devices, user interfaces for such devices, and associated processes for using such devices are described. In some embodiments, the device is a portable communications device, such as a mobile telephone, that also contains other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, California. Other portable electronic devices, such as wearables, laptops or tablet computers, are optionally used. In some embodiments, the device is not a portable communication device, but is a desktop computer or other computing device (e.g., a server) that is not designed for portable use. In some embodiments, the disclosed electronic device may include a touch-sensitive surface (e.g., a touch screen display and/or a touchpad). An example electronic device described below in conjunction with FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to some embodiments. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, headset jack 112, and docking/charging external port 124. Push button 106 may be used to turn the power on/off on device 100 by depressing button 106 and holding button 106 in the depressed state for a predefined time interval; to lock the device by depressing button 106 and releasing button 106 before the predefined time interval has elapsed; and/or to unlock device 100 or initiate an unlock process. Alternatively, in some embodiments, device 100 also accepts verbal input for activation or deactivation of some functions through microphone 113. Device 100 includes various components including a memory (which may include one or more computer readable storage mediums), a memory controller, one or more central processing units (CPUs), a peripherals interface, an RF circuitry, an audio circuitry, speaker 111, microphone 113, an input/output (I/O) subsystem, and other input or control devices. Device 100 may include one or more image sensors 164, one or more proximity sensors 166, and one or more accelerometers 168. Device 100 may include more than one type of image sensors 164. Each type may include more than one image sensor 164. For example, one type of image sensors 164 may be cameras and another type of image sensors 164 may be infrared sensors for facial recognition that is performed by one or more machine learning models stored in device 100. Device 100 may include components not shown in FIG. 1, such as an ambient light sensor, a dot projector and a flood illuminator that is to support facial recognition.

Device 100 is only one example of an electronic device, and device 100 may have more or fewer components than listed above, some of which may be combined into a component or have a different configuration or arrangement. In some embodiments, device 100 does not have audio/visual components, such as touch screen 150, speaker 111, or image sensors 164. The various components of device 100 listed above are embodied in hardware, software, firmware, or a combination thereof, including one or more signal processing and/or application-specific integrated circuits (ASICs).

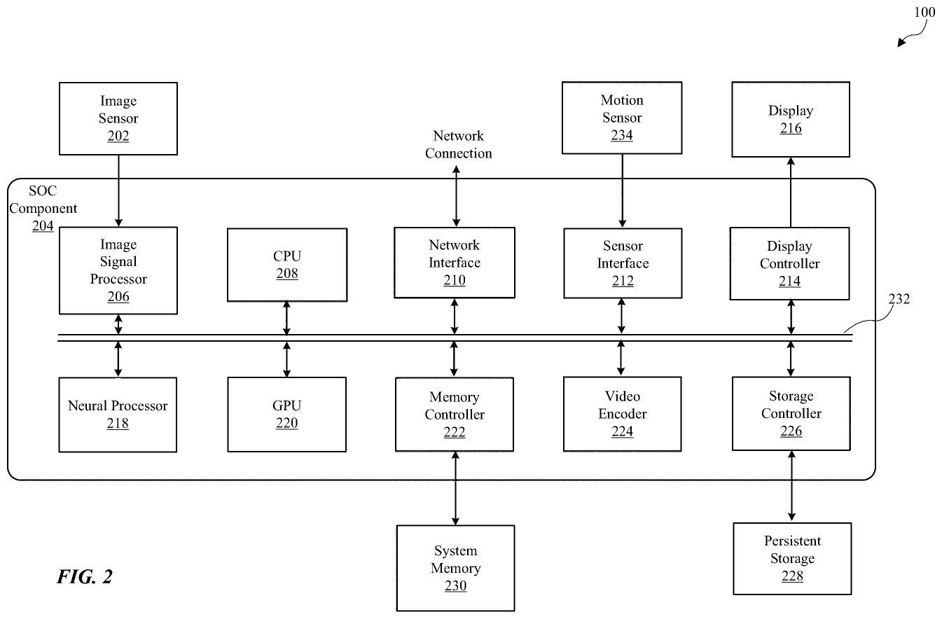

FIG. 2 is a block diagram illustrating components in device 100, according to some embodiments. Device 100 may perform various operations including implementing one or more machine learning models. For this and other purposes, device 100 may include, among other components, image sensors 202, a system-on-a-chip (SOC) component 204, a system memory 230, a persistent storage (e.g., flash memory) 228, a motion sensor 234, and a display 216. The components as illustrated in FIG. 2 are merely illustrative. For example, device 100 may include other components (such as a speaker or a microphone) that are not illustrated in FIG. 2. Further, some components (such as motion sensor 234) may be omitted from device 100.

An image sensor 202 is a component for capturing image data and may include, for example, a complementary metal-oxide-semiconductor (CMOS) active-pixel sensor, a camera, video camera, or other devices. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color filter array (CFA) pattern. It is noted that the raw image data may be in other formats or patterns.

Motion sensor 234 is a component or a set of components for sensing motion of device 100. Motion sensor 234 may generate sensor signals indicative of orientation and/or acceleration of device 100. The sensor signals are sent to SOC component 204 for various operations, such as turning on device 100 or rotating images displayed on display 216.

Display 216 is a component for displaying images as generated by SOC component 204. Display 216 may include, for example, a liquid crystal display (LCD) device or an organic light-emitting diode (OLED) device. Based on data received from SOC component 204, display 116 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may include any type of memory including, for example, dynamic random access memory (DRAM), synchronous DRAM (SDRAM), double data rate (DDR, DDR2, DDR3, etc.) RAMBUS DRAM (RDRAM), static RAM (SRAM), or a combination thereof.

Persistent storage 228 is a component for storing data in a non-volatile manner. Persistent storage 228 retains data even when power is not available. Persistent storage 228 may include read-only memory (ROM), flash memory or other non-volatile random access memory devices. Persistent storage 228 stores an operating system of device 100 and various software applications. Persistent storage 228 may also store one or more machine learning models, such as regression models, random forest models, support vector machines (SVMs) such as kernel SVMs, and artificial neural networks (ANNs) (e.g., convolutional network networks (CNNs), recurrent network networks (RNNs), autoencoders, and long short term memory (LSTM)-based neural networks). A machine learning model may be an independent model that works with a neural processor 218 and various software applications or sensors of device 100. A machine learning model may also be part of a software application. The machine learning models may perform various tasks, such as facial recognition, image classification, video classification, object, concept and information classification, speech recognition, machine translation, voice recognition, voice command recognition, text recognition, text and context analysis, other natural language processing, predictions, and recommendations.

Various machine learning models stored in device 100 may be fully trained, untrained, or partially trained to allow device 100 to reinforce or continue to train the machine learning models as device 100 is used. Operations of the machine learning models include various computation used in training the models and determining results during runtime using the models. For example, device 100 captures facial images of the user and uses the images to continue to improve a machine learning model that is used to lock or unlock the device 100.

SOC component 204 may include one or more integrated circuit (IC) chips and performs various data processing processes. SOC component 204 may include, among other subcomponents, image signal processor (ISP) 206, a central processor unit (CPU) 208, a network interface 210, sensor interface 212, display controller 214, neural processor 218, graphics processor (GPU) 220, memory controller 222, video encoder 224, storage controller 226, a memory management unit (MMU) 236, and bus 232 connecting these subcomponents. SOC component 204 may include more or fewer subcomponents than those shown in FIG. 2.

ISP 206 may be implemented by processing logic that can include hardware (e.g., circuitry, dedicated logic, programmable logic, or microcode), software (e.g., instructions executing on a processing device), or a combination thereof. ISP 206 may perform various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations, such as image translation operations, horizontal and vertical scaling, color space conversion and/or image stabilization transformations.

CPU 208 may include any suitable instruction set architecture, and may be configured to execute instructions defined in that instruction set architecture. CPU 208 may be general-purpose or embedded processors using any of a variety of instruction set architectures (ISAs), such as the ×86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may implement the same ISA.

Graphics processing unit (GPU) 220 may include graphics processing circuitry for performing various operations, including graphics and video rendering. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

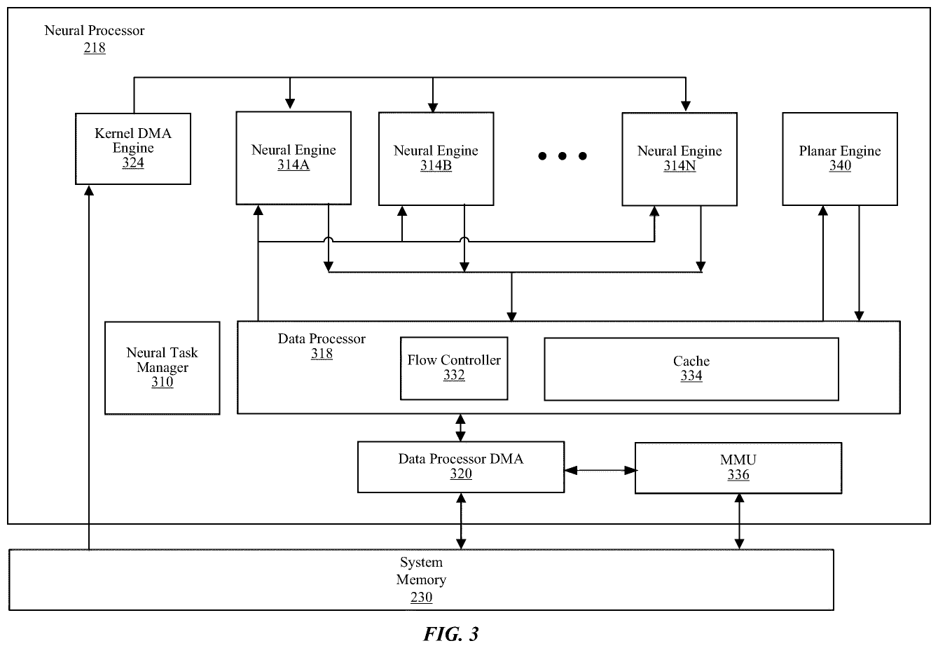

Neural processor 218 may be implemented by processing logic that can include hardware (e.g., circuitry, dedicated logic, programmable logic, or microcode), software (e.g., instructions executing on a processing device), or a combination thereof. Neural processor 218 may perform various machine learning operations based on computation including multiplication, addition, and accumulation. Such computation may be arranged to perform, for example, various types of tensor multiplications, such as tensor product and convolution of input data and kernel data (e.g., weights). Neural processor 218 may be configurable and may perform these operations in a fast and power-efficient manner while relieving CPU 208 of resource-intensive operations associated with neural network operations. Neural processor 218 may receive the input data from sensor interface 212, image signal processor 206, persistent storage 228, system memory 230 or other sources (e.g., network interface 210 or GPU 220). The output of neural processor 218 may be provided to various components of device 100, such as image signal processor 206, system memory 230 or CPU 208 for various operations. In some embodiments, neural processor 218 is implemented as a standalone processing unit on a device, such as device 100. In some embodiments, neural processor 218 is one multiple neural processors 218 connected by bus 232. The structure and operation of neural processor 218 are described below in detail with reference to FIG. 3.

Network interface 210 is a subcomponent that enables data to be exchanged between devices 100 and other devices via one or more networks (e.g., carrier or agent devices). For example, audio, video, or other image data may be received from other devices via network interface 210 and be stored in system memory 230 for subsequent processing (e.g., via a back-end interface to image signal processor 206) and display. The networks may include Local Area Networks (LANs) (e.g., an Ethernet or corporate network) and Wide Area Networks (WANs). The image data received via network interface 210 may undergo image processing processes by ISP 206.

Sensor interface 212 may be implemented by processing logic that can include hardware (e.g., circuitry, dedicated logic, programmable logic, or microcode), software (e.g., instructions executing on a processing device), or a combination thereof. Sensor interface 212 interfaces with motion sensor 234. Sensor interface 212 receives sensor information from motion sensor 234 and processes the sensor information to determine the orientation or movement of device 100.

Display controller 214 may be implemented by processing logic that can include hardware (e.g., circuitry, dedicated logic, programmable logic, or microcode), software (e.g., instructions executing on a processing device), or a combination thereof. Display controller 214 may provide video or image data to display 216 for display thereby. Display controller 214 may receive the video or image data from ISP 206, CPU 208, GPU 220, or system memory 230 and may process the video or image data into a format suitable for display on display 216.

Memory controller 222 may be implemented by processing logic that can include hardware (e.g., circuitry, dedicated logic, programmable logic, or microcode), software (e.g., instructions executing on a processing device), or a combination thereof. Memory controller 222 may communicate with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 may be implemented by processing logic that can include hardware (e.g., circuitry, dedicated logic, programmable logic, or microcode), software (e.g., instructions executing on a processing device), or a combination thereof. Video encoder 223 may encode video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on neural processor 218, ISP 206, CPU 208 or GPU 220. Such software components may be stored in system memory 230, persistent storage 228 or another device communicating with device 100 via network interface 210.

Neural processor 218 may be configured to perform machine learning operations on the input data of neural processor 218. Machine learning operations may include different computations for training of a machine learning model and for performing inference or prediction based on the trained machine learning model.

Taking an example of a CNN as the machine learning model, training of the CNN may include forward propagation and backpropagation. A neural network may include an input layer, an output layer, and one or more intermediate layers that may be referred to as “hidden layers.” Each layer may include one or more nodes (or neurons), which may be fully or partially connected to other nodes in adjacent layers. During forward propagation, the neural network performs computation in the forward direction based on outputs of a preceding layer. The operation of a node may be defined by one or more functions. The functions that define the operation of a node may include various computation operations, such as convolution of data with one or more kernels, pooling of layers, tensor multiplication, etc. The functions may also include an activation function that adjusts the weight of the output of the node. Nodes in different layers may be associated with different functions. For example, a CNN may include one or more convolutional layers that are mixed with pooling layers and are followed by one or more fully connected layers.

Each of the functions, including kernels, in a machine learning model may be associated with different coefficients that are adjustable during training. In addition, some of the nodes in a neural network each may also be associated with an activation function that decides the weight of the output of the node in a forward propagation. Common activation functions may include step functions, linear functions, sigmoid functions, hyperbolic tangent functions (tanh), and rectified linear unit (ReLU) functions. After a batch of data of training samples passes through a neural network in the forward propagation, the results may be compared to the training labels of the training samples to compute the network's loss function, which represents the performance of the network. In turn, the neural network performs backpropagation by using coordinate descent, such as stochastic coordinate descent (SGD), to adjust the coefficients in various functions to improve the value of the loss function.

During training, device 100 may use neural processor 218 to perform all or some of the operations in the forward propagation and backpropagation. Multiple rounds of forward propagation and backpropagation may be performed by neural processor 218, solely or in coordination with other processors, such as CPU 208, GPU 220, and ISP 206. Training may be completed when the loss function no longer improves (e.g., the machine learning model has converged) or after a predetermined number of rounds for a particular set of training samples. As device 100 is used, device 100 may continue to collect additional training samples for the neural network.

During prediction or inference, device 100 may receive one or more input samples. Neural processor 218 may take the input samples to perform forward propagation to determine one or more results. The input samples may be images, speeches, text files, sensor data, video data, audio data, or other data.

Data and functions (e.g., input data, kernels, functions, layer outputs, gradient data, etc.) in machine learning may be saved and represented by one or more tensors. Common operations related to training and runtime of a machine learning model may include tensor product, tensor transpose, tensor elementwise operation, convolution, application of an activation function, automatic differentiation to determine gradient, statistics and aggregation of values in tensors (e.g., average, variance, standard deviation), tensor rank and size manipulation, etc.

While the training and runtime of a neural network is discussed as an example, the neural processor 218 may also be used for the operations of other types of machine learning models, such as a kernel support vector machine (SVM) model.

Referring to FIG. 3, an example neural processor 218 may include, among other components, a neural task manager 310, neural network engines 314A through 314N (hereinafter collectively referred as “neural engines 314” and individually also referred to as “neural engine 314”), a kernel direct memory access (DMA) engine 324, a data processor 318, a data processor DMA engine 320, a memory management unit (MMU) 336, and a planar engine 340. Neural processor 218 may include fewer or additional components not illustrated in FIG. 3.

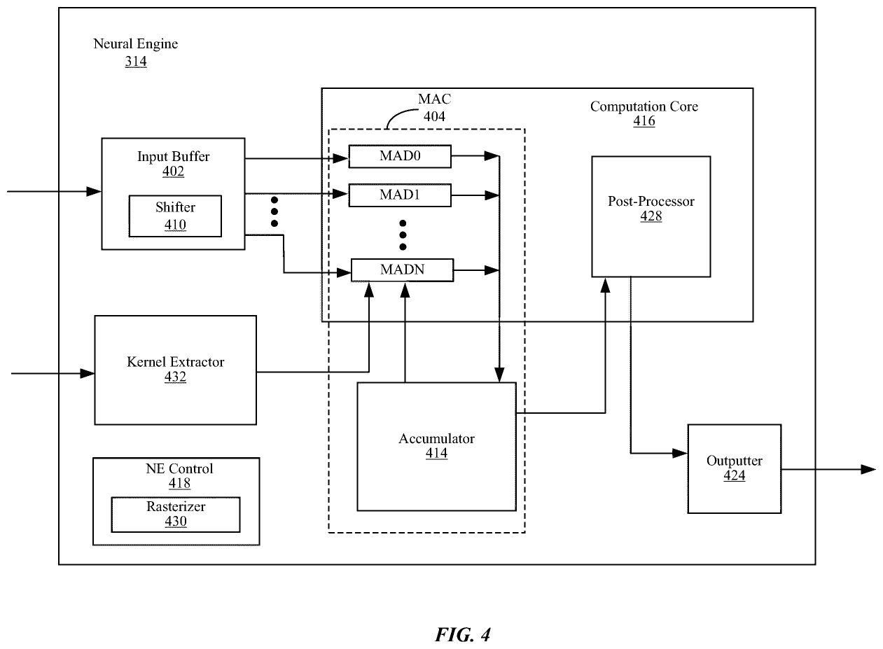

Each of neural engines 314 performs computing operations for machine learning in parallel. Depending on the load of operation, the entire set of neural engines 314 may be operating or only a subset of neural engines 314 may be operating while the remaining neural engines 314 are placed in a power-saving mode to conserve power. Each of neural engines 314 includes components for storing one or more kernels, for performing multiply—accumulate operations, activation functions, and for post-processing to generate output data, as described below in detail with reference to FIG. 4. Neural engines 314 may specialize in performing computationally heavy operations, such as matrix multiplication operations, convolution operations, and tensor product operations. Convolution operations may include different kinds of convolutions, such as cross-channel convolutions (e.g., a convolution that accumulates values from different channels), channel-wise convolutions, and transposed convolutions.

Planar engine 340 may specialize in performing simpler computing operations, where speed may primarily depend on the input and output (I/O) speed of the data transmission instead of the computation speed within planar engine 340. Those computing operations may be referred to as “I/O bound computations.” In contrast, neural engines 314 may focus on complex computations, where speed may primarily depend on the computation speed within each neural engine 314. For example, planar engine 340 is efficient at performing operations within a single channel while neural engines 314 are efficient at performing operations across multiple channels that may involve heavy accumulation of data. The use of neural engine 314 to compute I/O bound computations may not be efficient in terms of both speed and power consumption. In some embodiments, input data may be a tensor whose rank is larger than three (e.g., having three or more dimensions). A set of dimensions (two or more) in the tensor may be referred to as a “plane,” while another dimension may be referred to as a “channel.” Neural engines 314 may convolve data of a plane in the tensor with a kernel and accumulate results of the convolution of different planes across different channels. On the other hand, planar engine 340 may specialize in operations within the plane.

Planar engine 340 may be programmed for operation in one of multiple modes, including a pooling mode, an elementwise mode, and a reduction mode. In the pooling mode, planar engine 340 reduces a spatial size of input data. In the elementwise mode, planar engine 340 generates an output that is derived from elementwise operations of one or more inputs. In the reduction mode, planar engine 340 reduces the rank of a tensor. For example, a rank 5 tensor may be reduced to a rank 2 tensor, or a rank 3 tensor may be reduced to a rank 0 tensor (e.g., a scalar).

Neural task manager 310 manages the overall operation of neural processor 218. Neural task manager 310 may receive a task list from a compiler executed by CPU 208, store tasks in its task queues, choose a task to perform, and send task commands to other components of neural processor 218 for performing the chosen task. Data may be associated with a task command that indicates the types of operations to be performed on the data. Data of neural processor 218 includes input data that is transmitted from another source, such as system memory 230, and data generated by neural processor 218 in a previous operation cycle. Each dataset may be associated with a task command that specifies the type of operations to be performed on the data. Neural task manager 310 may also perform switching of tasks on detection of events, such as receiving instructions from CPU 208. In some embodiments, neural task manager 310 sends rasterizer information to the components of neural processor 218 to enable each of the components to track, retrieve, or process appropriate segments of the input data and kernel data. For example, neural task manager 310 may include registers that stores the information regarding the size and rank of a dataset for processing by neural processor 218.

For instance, input data may be split into smaller pieces of data for parallel processing at multiple neural engines 314 and planar engine 340. In some embodiments, a set of data used for a convolution operation may be a subset of data from a token. A set of data used for a convolution operation may be referred to as a “convolution group,” which can be split into multiple smaller units. The hierarchy of smaller units (segments) may be convolution groups, slices, tiles, work units (WUs), output channel groups, input channels (Cin), sub-Cins for input stride, etc. For example, a convolution group may be split into several slices; a slice may be split into several tiles; a tile may be split into several work units; and so forth. In the context of neural engine 314, a work unit may be a segment of the input data, such as data processed by planar engine 340 or data processed in a prior cycle of neural engines 314, having a size suitable for an accumulator (e.g., accumulator 414, as shown in FIG. 4) of neural engines 314. In one case, the size of each work unit is 256 bytes. In some embodiments, work units can be shaped to one of 16×16, 32×8, 64×4, 128×2 or 256×1 datasets.

In an example in which an image is input to neural engines 314, the image may be represented as a multi-dimensional matrix, where each dimension includes one or more segments (e.g., work units) of the input data. In an example, a first dimension corresponds to the width (w) of the image, a second dimension corresponds to the height (h) of the image, and a third dimension corresponds to a depth or color channel (c) of the image (e.g., a red channel, a blue channel, or a green channel for a red, green, blue (RGB) image). It is noted that this is merely one example of a channel and that input data can have any number of channels depending on the features extracted from the input data.

In the context of planar engine 340, a work unit may be (i) a segment of input data, (ii) data from neural engine 314, or (iii) data from a prior cycle of planar engine 340 that can be processed simultaneously at planar engine 340. Although neural task manager 310 is illustrated in FIG. 3 as part of neural processor 218, neural task manager 310 may be a component outside neural processor 218.

Kernel DMA engine 324 may be implemented by processing logic that can include hardware (e.g., circuitry, dedicated logic, programmable logic, or microcode), software (e.g., instructions executing on a processing device), or a combination thereof. Kernel DMA engine 324 may be configured to fetch kernel data (e.g., kernel coefficients) from a source (e.g., system memory 230) and sends kernel coefficients to each of neural engines 314. The kernel coefficients may be stored in a kernel matrix, which is stored in a portion of system memory 230 that is allocated and configured to store the kernel matrix. Kernel data represents information from which kernel elements can be extracted. In some embodiments, the kernel data may be in a compressed format, which is decompressed at each of neural engines 314. Although kernel data provided to each of neural engines 314 may be the same in some instances, the kernel data provided to each of neural engines 314 is different in most instances. In some embodiments, the direct memory access nature of kernel DMA engine 324 may allow kernel DMA engine 324 to fetch and write data directly from the source without the involvement of CPU 208.

Data processor 318 may be implemented by processing logic that can include hardware (e.g., circuitry, dedicated logic, programmable logic, or microcode), software (e.g., instructions executing on a processing device), or a combination thereof. Data processor 318 may be configured to manage data traffic and task performance of neural processor 218. Data processor 318 may include a flow controller 332 and a cache 334. Cache 334 is temporary storage for storing data associated with operations of neural processor 218 and planar engine 340, such as input data that is transmitted to and/or received from system memory 230 (e.g., data from a machine learning model) and other data that is generated within neural processor 218 or planar engine 340. The data stored in cache 334 may include different subsets that are sent to various downstream components, such as neural engines 314 and planar engine 340. In one example, cache 334 may be a level 2 (L2) cache.

In some embodiments, cache 334 includes a non-transitory memory that can be accessed by neural engines 314 and planar engine 340. Cache 334 may store input data for feeding to corresponding neural engines 314A through 314N or planar engine 340, as well as output data from each of neural engines 314A through 314N or planar engine 340 for feeding back into one or more neural engines 314 or planar engine 340, or sending to a target circuit (e.g., system memory 230). Cache 334 may also store input data and output data of planar engine 340 and allow the exchange of data between neural engine 314 and planar engine 340. For example, one or more the output data of neural engines 314 are used as input data to planar engine 340. Likewise, the output of planar engine 340 may be used as input data of neural engines 314. The inputs of neural engines 314 or planar engine 340 may be any data stored in cache 334. For example, in various operating cycles, the source datasets from one of the engines (e.g., neural engines 314 or planar engine 340) fetches as inputs may be different. The input of an engine may be an output of the same engine in previous cycles, outputs of different engines, or any other suitable source datasets stored in buffer memory 334. Also, a dataset in cache 334 may be divided and sent to different engines for different operations in the next operating cycle. Two datasets in cache 334 may also be joined for the next operation.

Flow controller 332 of data processor 318 may be implemented by processing logic that can include hardware (e.g., circuitry, dedicated logic, programmable logic, or microcode), software (e.g., instructions executing on a processing device), or a combination thereof. Flow controller 332 may be configured to control the exchange of data between neural engines 314 and planar engine 340. The operations of data processor 318 and other components of neural processor 218 are coordinated so that the input data and intermediate data stored in data processor 318 may be reused across multiple operations at neural engines 314 and planar engine 340, thereby reducing data transfer to and from system memory 230. Flow controller 332 may perform one or more of the following operations: (i) monitor the size and rank of data (e.g., data may be one or more tensors) that are being processed by neural engines 314 and planar engine 340, (ii) determine which subsets of data are transmitted to neural engines 314 or to planar engine 340 based on the task commands associated with different subsets of data, (iii) determine the manner in which data is transmitted to neural engines 314 and planar engine 340 (e.g., data processor 318 may operate in a broadcast mode where the same data is fed to multiple input channels of neural engines 314 so that multiple or all neural engines 314 receive the same data or in a unicast mode where different neural engines 314 receive different data), and (iv) transmit a configuration command to the planar engine 340 to direct planar engine 340 to program itself for operating in one of multiple operation modes.

The data of neural processor 218 stored in cache 334 may be part of, among others, image data, histogram of oriented gradients (HOG) data, audio data, metadata, output data of a previous cycle of a neural engine 314, and other processed data received from other components of the SOC component 204.

As described above, neural engines 314 may be configured to perform matrix multiplication operations, for example, when executing a large language model (LLM). Such operations may be performed as a multi-channel 1×1 convolution, where a 1×1 filter including a single weight for each channel. The filter may be applied to an input feature map with a stride of one (e.g., left-to-right and top-to-bottom) resulting in an output feature map (also referred to as an “activation map”) with the same width and height as the input. One or more activation functions may also be applied on the output feature map (e.g., step functions, linear functions, sigmoid functions, tanh functions, and/or ReLU functions).

Data processor DMA engine 320 may be implemented by processing logic that can include hardware (e.g., circuitry, dedicated logic, programmable logic, or microcode), software (e.g., instructions executing on a processing device), or a combination thereof. Data processor DMA engine 320 may be configured to receive at least a portion (e.g., a work unit or a tile) of the input data from a source (e.g., system memory 230) for storing in cache 334, and/or write at least a portion of data from cache 334 to a target (e.g., system memory 230).

MMU 336 may be implemented by processing logic that can include hardware (e.g., circuitry, dedicated logic, programmable logic, or microcode), software (e.g., instructions executing on a processing device), or a combination thereof. MMU 336 may be configured to translate virtual memory addresses to physical memory addresses for retrieval of memory pages stored in system memory 230. Additional details regarding MMU 336 are provided below with reference to FIG. 5.

FIG. 4 is a block diagram of neural engine 314, according to some embodiments. Neural engine 314 performs various operations to facilitate machine learning, such as convolution (e.g., matrix multiplication), tensor product, and other operations that may involve heavy computations. For this purpose, neural engine 314 receives the input data, performs multiply-accumulate operations (e.g., convolution operations) on the input data based on the stored kernel coefficients received from kernel DMA engine 324, performs further post-processing operations on the result of the multiply-accumulate operations, and generates output data. The input data obtained by neural engine 314 and/or the output data provided by neural engine 314 may be of a single channel or span across multiple channels.

Neural engine 314 may include, among other components, an input buffer 402, a computation core 416, a neural engine (NE) control 418, an accumulator 414, an outputter 424, and a kernel extractor 432. Neural engine 314 may include fewer components than what is illustrated in FIG. 4 or include further components not illustrated in FIG. 4.

Input buffer 402 may be implemented by processing logic that can include hardware (e.g., circuitry, dedicated logic, programmable logic, or microcode), software (e.g., instructions executing on a processing device), or a combination thereof. Input buffer 402 may store a subset of the input data of neural processor 218 as the subset of the input data is received from a source. The source may be data processor 318, planar engine 340, or another suitable component. Input buffer 402 may send an appropriate segment of input data for a current task or process loop to computation core 416 for processing. Input buffer 402 may include a shifter 410 that shifts read locations of input buffer 402 to change the segment of the input data sent to computation core 416. By changing segments of the input data provided to computation core 416 via shifting, neural engine 314 can perform multiply-accumulate for different segments of the input data based on a fewer number of read operations. In some embodiments, the input data of neural processor 218 includes data of difference convolution groups and/or input channels.

Kernel extractor 432 is a circuit that receives kernel data from kernel DMA engine 324 and extracts kernel coefficients. In some embodiments, kernel extract circuit 432 is a circuit that receives kernel data 326 from kernel DMA 324 and extracts kernel coefficients 422. In some embodiments, the kernel extract circuit 432 references a data structure (e.g., look up table (LUT)) and uses a mask to reconstruct a kernel from compressed kernel data. The mask indicates locations in the reconstructed kernel to be padded with zeroes and remaining locations to be filled with numbers. The kernel coefficients of the reconstructed kernel are sent to computation core 416 to populate registers in multiply-add (MAD) circuits of computation core 416. In some embodiments, kernel extractor 432 receives kernel data in an uncompressed format and the kernel coefficients are determined without referencing the data structure or using a mask. The determined kernel coefficients are provided to computation core 416, for example, to perform a convolution operation utilizing MAD circuits MADO through MADN.

Computation core 416 may be implemented by processing logic that can include hardware (e.g., circuitry, dedicated logic, programmable logic, or microcode), software (e.g., instructions executing on a processing device), or a combination thereof. Computation core 416 may be configured to perform computation operations. For this purpose, computation core 416 may include MAD circuits MADO through MADN and a post-processor 428. Each of MAD circuits MADO through MADN may store an input value in the segment of the input data and a corresponding kernel coefficient from the kernel coefficients received from kernel DMA engine 324. The input value and the corresponding kernel coefficient are multiplied in each of MAD circuits MADO through MADN to generate a processed value.

Accumulator 414 may be implemented by processing logic that can include hardware (e.g., circuitry, dedicated logic, programmable logic, or microcode), software (e.g., instructions executing on a processing device), or a combination thereof. Accumulator 414 may be configured to receive and store processed values from MAD circuits MADO through MADN. The processed values stored in accumulator 414 may be sent back as feedback information for further multiply and add operations at MAD circuits or sent to post-processor 428 for post-processing. Accumulator 414 in combination with MAD circuits form a multiply-accumulator (MAC) 404.

Post-processor 428 may be implemented by processing logic that can include hardware (e.g., circuitry, dedicated logic, programmable logic, or microcode), software (e.g., instructions executing on a processing device), or a combination thereof. Post-processor 428 may be configured to further process values received from accumulator 414. Post-processor 428 may perform operations including applying linear functions (e.g., Rectified Linear Unit (ReLU)), normalized cross-correlation (NCC), merging the results of performing neural operations on 8-bit data into 16-bit data, and local response normalization (LRN). The result of such operations is output from post-processor 428 as processed values to outputter 424. In some embodiments, the processing at the post-processor 428 is bypassed. For example, the data in accumulator 414 may be sent directly to outputter 424 for access by other components of neural processor 218.

NE control 418 may be implemented by processing logic that can include hardware (e.g., circuitry, dedicated logic, programmable logic, or microcode), software (e.g., instructions executing on a processing device), or a combination thereof. NE control 418 may be configured to control operations of other components of neural engine 314 based on the operation modes and parameters of neural processor 218. Depending on different modes of operation (e.g., group convolution mode or non-group convolution mode) or parameters (e.g., the number of input channels and the number of output channels), neural engine 314 may operate on different input data in different sequences, return different values from accumulator circuit 414 to MAD circuits, and perform different types of post-processing operations at post-processor 428. To configure components of neural engine 314 to operate in a desired manner, NE control 418 sends task commands that may be included in the feedback information to components of neural engine 314. NE control 418 may include a rasterizer 430 that tracks the current task or process loop being processed at neural engine 314.

Rasterizer 430 may be implemented by processing logic that can include hardware (e.g., circuitry, dedicated logic, programmable logic, or microcode), software (e.g., instructions executing on a processing device), or a combination thereof. Rasterizer 430 may be configured to perform the operations associated with dividing the input data into smaller units (segments) and regulate the processing of the smaller units through the MACs 404 and accumulator 414. Rasterizer 430 may keep track of sizes and ranks of segments of the input/output data (e.g., groups, work units, input channels, output channels) and instructs the components of neural processor 218 for proper handling of the segments of the input data. For example, rasterizer 430 operates shifters 410 in input buffer 402 to forward the correct segments 408 of input data to MAC 404 and send the finished output data to buffer cache 334. Other components of neural processor 218 (e.g., kernel DMA engine 324, cache 334, planar engine 340) may also have their corresponding rasterizers to monitor the division of input data and the parallel computation of various segments of input data in different components.

Outputter 424 may be implemented by processing logic that can include hardware (e.g., circuitry, dedicated logic, programmable logic, or microcode), software (e.g., instructions executing on a processing device), or a combination thereof. Outputter 424 may receive the processed values from post-processor 428 and interface with data processor 318 to store the processed values in data processor 318. For this purpose, outputter 424 may send output data in a sequence or a format that is different from the sequence or format in which the processed values are processed in post-processor 428.

The components in neural engine 314 may be configured during a configuration period by NE control 418 and neural task manager 310. For this purpose, neural task manager 310 sends configuration information to neural engine 314 during the configuration period. The configurable parameters and modes may include mapping between input data elements and kernel elements, the number of input channels, the number of output channels, performing of output strides, and enabling/selection of post-processing operations at post-processor 428.

FIG. 5 is a block diagram of system 500 configured to perform virtual-to-physical address translations, according to some embodiments. As shown in FIG. 5, system 500 includes a processor 502, MMU 336, and system memory 230. Processor 506 is an example of CPU 208, GPU 220, neural engines 314, or planar engine 340. MMU 336 may include a translation lookaside buffer (TLB) 504, a lookup request generator 518, a miss handler 520, and an address generator 522. Each of TLB 504, lookup request generator 518, miss handler 520, and address generator 522 may be implemented by processing logic that can include hardware (e.g., circuitry, dedicated logic, programmable logic, or microcode), software (e.g., instructions executing on a processing device), or a combination thereof.

TLB 504 may be configured to cache relatively recent virtual-to-physical address translations. TLB 504 may include a first tag memory device 506, a second tag memory device 508, and a data memory device 510. Each of first tag memory device 506, second tag memory device 508, and data memory device 510 may include any type of memory including, for example, content addressable memory (CAM), dynamic random access memory (DRAM), synchronous DRAM (SDRAM), double data rate (DDR, DDR2, DDR3, etc.) RAMBUS DRAM (RDRAM), static RAM (SRAM), or a combination thereof. It is noted that while first tag memory device 506 and second tag memory device 508 are depicted as separate single-ported memory devices, the embodiments described herein are not so limited. For instance, first tag memory device 506 and second tag memory device 508 may be incorporated into a single memory device that is dual ported, thereby enabling parallel memory access via two ports.

System memory 230 may be configured to store one or more memory pages of varying sizes (e.g., 16 kilobytes (KBs) or 32 megabytes (MBs). For example, as shown in FIG. 5, system memory 230 may include page(s) 512 having a first size (e.g., 16 KBs) and may include page(s) 514 having a second size (e.g., 32 MBs). Each of page(s) 512 and 514 may be allocated in system memory 230 by an operating system for one or more computing processes (e.g., software applications). Page(s) 512 and/or page(s) 514 allocated for a particular application may be stored in contiguous or non-contiguous locations in system memory 230. System memory 230 may also be configured to store a page table 516 for each computing process. Page table 516 may include page table entries for page(s) 512 and page(s) 514. Each page table entry may include an indication (e.g., a valid bit) as to whether a particular page of page(s) 512 and page(s) 514 is present in system memory 230, a virtual address for the particular page, a physical address at which the particular page is stored in system memory 230, and/or an indication (e.g., one or more protection bits) as to whether the page is executable, writeable, read-only, and/or writeable and readable by a computing process. It is noted that the virtual address may not be explicitly stored in system memory 230 and that the virtual address of the page table entry may be inferred from the offset of the page (e.g., page 512 or page 514) from the start of page table 512.

First tag memory device 506 and second tag memory device 508 may be configured to store cached virtual addresses for pages of different sizes and an indication (e.g., a valid bit) for each cached virtual address that indicates whether the virtual address is valid. For example, first tag memory device 506 may be configured to store virtual addresses for pages having a size of 16 KBs, and second tag memory device 508 may be configured to store virtual addresses for pages having a size of 32 MBs. It is noted that the page sizes described herein are exemplary and that each of first tag memory device 506 and second tag memory device 508 may be configured to store pages of other sizes. Each of first tag memory device 506 and second tag memory device 508 may be a set-associative memory, where each of first tag memory device 506 and second tag memory device 508 is divided into a number of sets. Each set may include a number of ways, with each way of a set storing a virtual address.

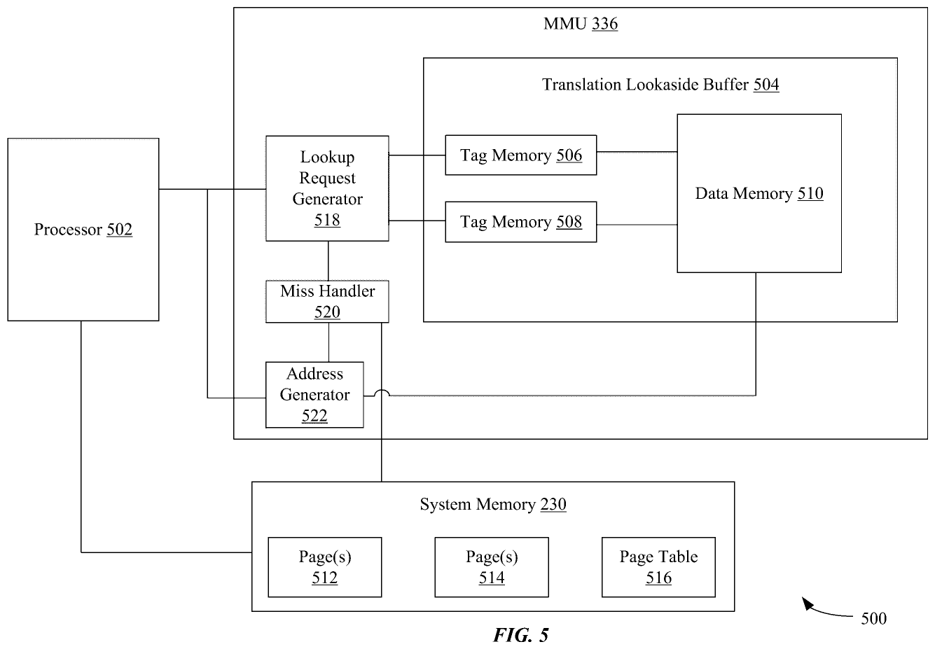

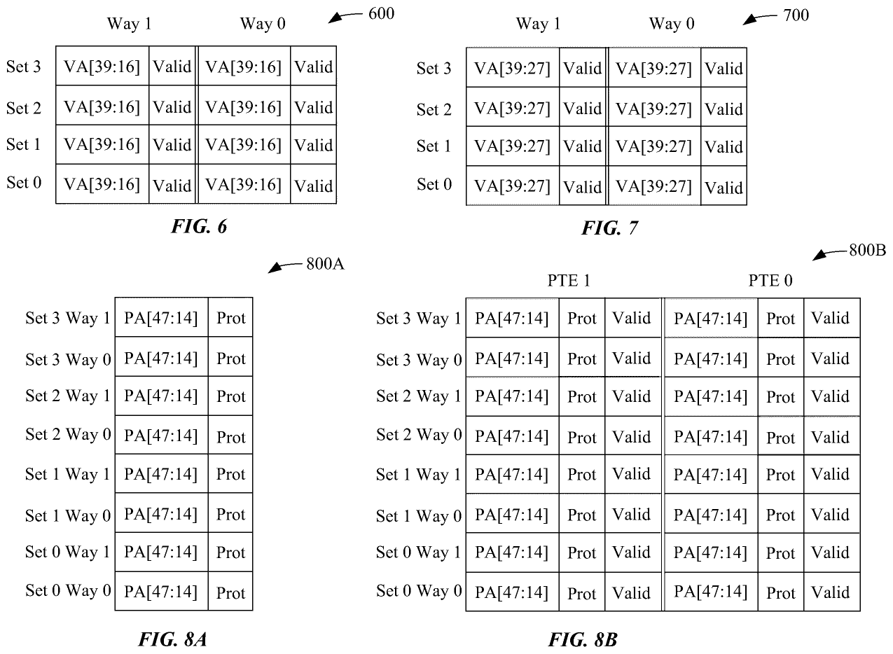

For example, FIGS. 6 and 7 are block diagrams of a first tag memory device 600 and a second tag memory device 700, respectively, according to some embodiments. First tag memory device 600 is an example of first tag memory device 506, and second tag memory device 700 is an example of second tag memory device 508. In the examples shown in FIGS. 6 and 7, virtual addresses have a bit width of 40 bits, first tag memory device 600 is configured to store first portions of such virtual addresses for pages having a page size of 16 KB, and tag memory device 700 is configured to store second portions of such virtual addresses for pages having a page size of 32 MB. As further shown in FIGS. 6 and 7, each row corresponds to a particular set, and each set includes two ways. As shown in FIG. 6, each way of each set stores the most significant 24 bits of a particular virtual address and an associated valid bit. As shown in FIG. 7, each way of each set stores the most significant 13 bits of a particular virtual address and an associated valid bit. It is noted that each of first tag memory device 600 and second tag memory device 700 may include any number of sets and ways for each set, and the number of sets and ways described herein are exemplary.

Referring again to FIG. 5, data memory device 510 may be configured to store cached page table entries of page table 516. For example, data memory device 510 may be configured to store cached physical addresses and corresponding valid and/or protection bits for page(s) 512 and page(s) 514. Accordingly, data memory device 510 may store physical addresses for pages of varying sizes (e.g., 16 KBs and 32 MBs). Data memory device 510 may be a set-associative memory, where data memory device 510 is divided into a number of sets. Each set may include a number of ways, with each way of a set storing a page table entry. In some embodiments, each way may store page table entries (e.g., 2, 4, or 8).

For example, FIGS. 8A and 8B are block diagrams of a data memory device 800A and a data memory device 800B, respectively, according to some embodiments. Data memories 800A and 800B are examples of data memory device 510. In the examples shown in FIGS. 8A and 8B, physical addresses have a bit width of 48 bits, and data memories 800A and 800B are configured to store portions of such physical addresses for both pages having a page size of either 16 KB (e.g., PA[47:14]) and pages having a page size of 32 MB (e.g., PA[47: 25]). In the embodiment shown in FIG. 8A, each row stores one cached page table entry of page table 516 (including both a portion of a physical address and its associated protection bits). In the embodiment shown in FIG. 8B, data memory device 800B is configured to store multiple (e.g., two) page table entries per way. In accordance with such embodiments, each page table entry includes a portion of a particular physical addresses, one or more protection bits associated with the physical address, and a valid bit that indicates that the associated cached portion of the physical address is valid. Each row is also mapped to a particular set and way of one of first tag memory device 600 or second tag memory device 700. It is noted that each of data memory devices 800A or 800B may include any number of sets and ways for each set, and the number of sets and ways described herein are exemplary.

Referring again to FIG. 5, to obtain one of pages of page(s) 512 or 514 located at a particular virtual address, processor 502 may provide a translation request to lookup request generator 518 of MMU 336. The translation request may indicate the virtual address to be translated. In an example, the translation request may indicate a 40-bit virtual address. Based on the translation request, lookup request generator 518 may generate and transmit a first lookup request to first tag memory device 506 and generate and transmit a second lookup request to second tag memory device 508. The first lookup request may be transmitted in parallel to the second lookup request (e.g., both the first lookup request and the second lookup request may be transmitted simultaneously during the same clock cycle). The lookup requests are configured to determine whether the virtual address is cached in one of first tag memory device 506 or second tag memory device 508.

In an example in which first tag memory device 506 is configured to store virtual addresses for 16 KB pages and data memory device 510 is configured to store one page table entry per way, the first lookup request may indicate 26 address bits of the virtual address (e.g., the 26 most significant bits of the virtual address (e.g., VA[39: 14])). First tag memory device 506 may be configured to determine whether the virtual address indicated by the first lookup request is cached in first tag memory device 506. For instance, in an embodiment in which first tag memory device 506 includes four sets, first tag memory device 506 may utilize a first portion of the virtual address (e.g., the least two most significant bits (VA[15: 14])) to select a set from the four different sets (e.g., as shown in FIG. 6). First tag memory device 506 may check each way of the selected set and determine whether a second portion (or “tag” portion) of the virtual address (e.g., VA[39: 16]) is stored therein. If the second portion of the virtual address is cached in one of the ways of the selected set, first tag memory device 506 determines whether the valid bit associated with the way is set. If the valid bit is set, then first tag memory device 506 provides an indication to lookup request generator 518 that the second portion of the virtual address is stored in first tag memory device 506 (e.g., an indication that a tag memory hit occurred). Otherwise, first tag memory device 506 provides an indication to lookup request generator 518 that the second portion of the virtual address is not stored in first tag memory device 506 (e.g., an indication that a tag memory miss occurred).

In an example in which second tag memory device 508 is configured to store virtual addresses for 32 MB pages and data memory device 510 is configured to store one page table entry per way, the second lookup request may indicate 15 address bits of the virtual address (e.g., the 15 most significant bits of the virtual address (e.g., VA[39: 25])). Second tag memory device 508 may be configured to determine whether the virtual address indicated by the second lookup request is stored in second tag memory device 508. For instance, in an embodiment in which second tag memory device 508 includes four sets, second tag memory device 508 may utilize a first portion of the virtual address (e.g., the least two most significant bits (VA[26: 25])) to select a set from the four different sets (e.g., as shown in FIG. 7). Second tag memory device 508 may check each way of the selected set and determine whether a second portion (or “tag” portion) of the virtual address (e.g., VA[39: 27]) is stored therein. If the second portion of the virtual address is stored in one of the ways of the selected set, second tag memory device 508 determines whether the valid bit associated with the way is set. If the valid bit is set, then second tag memory device 508 provides an indication to lookup request generator 518 that the second portion of the virtual address is stored in second tag memory device 508 (e.g., an indication that a tag memory hit occurred). Otherwise, second tag memory device 508 provides an indication to lookup request generator 518 that the second portion of the virtual address is not stored in second tag memory device 508 (e.g., an indication that a tag memory miss occurred).

If both of first tag memory device 506 and second tag memory device 508 return an indication of a tag memory miss, lookup request generator 518 may provide an indication to miss handler 520 that neither first tag memory device 506 nor second tag memory device 508 store the virtual address. Miss handler 520 may be configured to obtain the physical address corresponding to the virtual address indicated by the translation request from page table 516 based on the indication. Such a process may be referred to as a table walk, where miss handler 520 looks up the virtual-to-physical address mapping from page table 516. Miss handler 520 may write the physical address returned from page table 516 to a particular way in data memory device 510, may store the virtual address in a particular way of the determined set of first tag memory (if the page is a 16 KB page) or a particular way in the determined set of second tag memory (if the page is a 32 MB page), and may set the associated valid bit of the particular way of the tag memory in which the virtual address is stored. Miss handler 520 may also provide the obtained physical address to address generator 522. If the page is a 16 KB page, address generator 522 may concatenate a portion of the obtained physical address (e.g., the most significant 34 bits (PA[47: 14])) with a portion of the virtual address (e.g., the least significant 14 bits (VA[13: 0])). If the page is a 32 MB page, address generator 522 may concatenate a portion of the obtained physical address (e.g., the most significant 23 bits (PA[47: 25])) with a portion of the virtual address (e.g., the least significant 25 bits (VA[24: 0])). Address generator 522 may return the concatenated address to processor 502, which retrieves the page from system memory 230 based on the concatenated address.

If first tag memory device 506 returns an indication of a tag memory hit, first tag memory device 506 provides a lookup request to data memory device 510. The lookup request may indicate the determined set and way in which the virtual address is located in first tag memory device 506. Data memory device 510 may obtain the physical address from a cached page table entry of data memory device 510 corresponding to the determined set and way (e.g., as shown in FIG. 8A) and provide the obtained physical address to address generator 522. Address generator 522 may concatenate the obtained physical address with a portion of the virtual address (e.g., the least significant 14 bits (VA[13: 0])). Address generator 522 may return the concatenated address to processor 502, which retrieves the page from the concatenated address.

If second tag memory device 508 returns an indication of a tag memory hit, second tag memory device 508 provides a lookup request to data memory device 510. The lookup request may indicate the determined set and way in which the virtual address is located in second tag memory device 508. Data memory device 510 may obtain the physical address from a cached page table entry of data memory device 510 corresponding to the determined set and way (e.g., as shown in FIG. 8A) and provide the obtained physical address to address generator 522. Address generator 522 may concatenate the obtained physical address with a portion of the virtual address (e.g., the least significant 25 bits (VA[24: 0])). Address generator 522 may return the concatenated address to processor 502, which retrieves the page from the concatenated address.

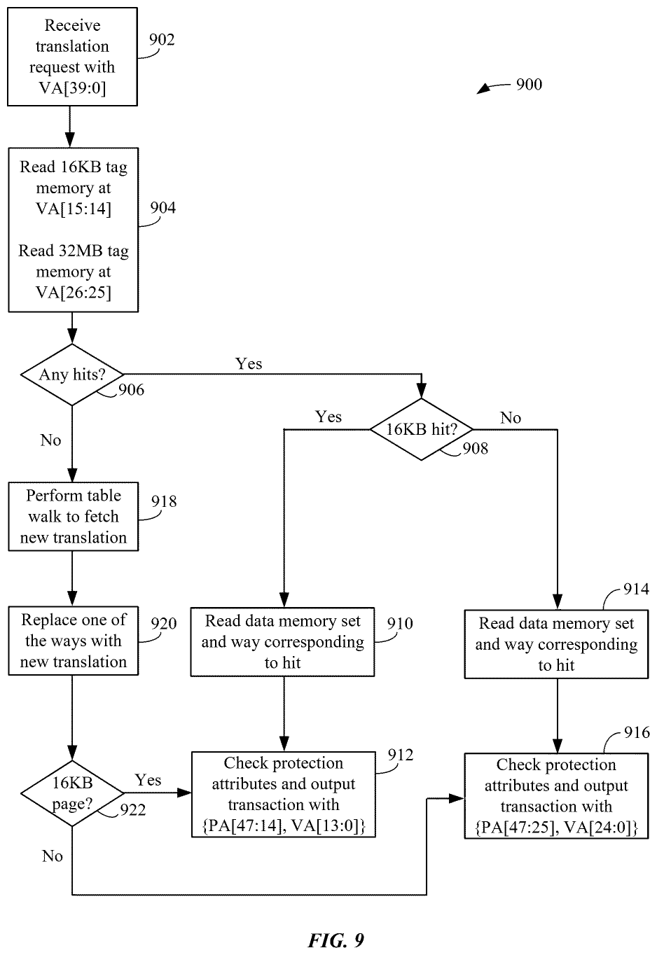

FIG. 9 is a flowchart for a method for performing a virtual-to-physical address translation based on a data memory configured to store one page table entry per way, according to some embodiments. Method 900 can be performed by processing logic that can include hardware (e.g., circuitry, dedicated logic, programmable logic, or microcode), software (e.g., instructions executing on a processing device), or a combination thereof. It is to be appreciated that not all steps may be needed to perform the disclosure provided herein. Further, some of the steps may be performed simultaneously, or in a different order than shown in FIG. 9, as will be understood by a person of ordinary skill in the art. Method 900 shall be described with reference to FIG. 5. In particular, method 900 shall be described in an example in which virtual addresses are 40 bits, physical addresses are 48 bits, first tag memory device 506 is configured to store portions of virtual addresses for 16KB pages (e.g., the 24 most significant bits (VA[39: 16])), second tag memory device 508 is configured to store portions of virtual addresses for 32MB pages (e.g., the 13 most significant bits [39: 27]), and data memory device 510 is configured to store one page table entry per way. Method 900 is not limited to those examples.

At 902, processor 502 may generate a translation request to translate a virtual address to a physical address. The translation request may indicate the 40-bit virtual address (e.g., VA[39: 0]) to be translated. The translation request is provided to and received by lookup request generator 518.

At 904, lookup request generator 518 may read first tag memory device 506 at a set indicated by virtual address bits [15: 14] to determine whether the virtual address is stored in first tag memory device 506. For example, lookup request generator 518 may generate a first lookup request including virtual address bits [39: 14]). First tag memory device 506 may be configured to determine whether the virtual address indicated by the first lookup request is stored in one of the ways of the set of first tag memory device 506 indicated by bits [15: 14], and if so, whether the valid bit associated with the set and way in which virtual address is stored is set. Lookup request generator 518 may also read second tag memory device 508 at a set indicated by virtual address bits [26: 25] to determine whether the virtual address is stored in second tag memory device 508. For example, lookup request generator 518 generate a second lookup request including virtual address bits [39: 25]). Second tag memory device 508 may be configured to determine whether the virtual address indicated by the second lookup request is stored in one of the ways of the set of second tag memory device 508 indicated by bits [26: 25], and if so, whether the valid bit associated with the set and way in which virtual address is stored is set.

At 906, lookup request generator 518 may determine whether a tag memory hit occurred with respect one of first tag memory device 506 or second tag memory device 508. For example, lookup request generator 518 may determine whether first tag memory device 506 or second tag memory device 508 returned an indication that the virtual address is stored in first tag memory device 506 or in second tag memory device 508, respectively. In response to determining that one of first tag memory device 506 or second tag memory device 508 returned such an indication, method 900 continues to operation 908. Otherwise, method 900 continues to operation 918.

At 908, lookup request generator 518 may determine whether a hit occurred with respect to first tag memory device 506 or second tag memory device 508. For example, if first tag memory device 506 provides an indication that the virtual address is stored therein, lookup request generator 518 determines that a hit occurred with respect to first tag memory device 506, and method 900 continues to operation 910. If second tag memory device 508 provides an indication that the virtual address is stored therein, lookup request generator 518 determines that a hit occurred with respect to second tag memory device 508, and method 900 continues to operation 914.

At 910, data memory device 510 is read at a location corresponding to the set and way at which the virtual address is stored in first tag memory device 506 to obtain a portion of the physical address stored at that set and way (e.g., PA[47: 14]).

At 912, data memory device 510 may check one or more protection bits associated with the set and way at which the portion of the physical address is stored to ensure that the page located at physical address is accessible by processor 502 (e.g., data memory device 510 may determine that the read protection bit is set). If processor 502 is enabled to access the page, then the portion of the physical address (e.g., PA[47: 14]) is provided to address generator 522, which concatenates the portion of the physical address with a portion of the virtual address (e.g., the least significant 14 bits (VA[13: 0])). Address generator 522 may return the concatenated address to processor 502, which retrieves the page from the concatenated address.

At 914, data memory device 510 is read at a location corresponding to the set and way at which the virtual address is stored in second tag memory device 508 to obtain a portion of the physical address stored at that set and way (e.g., PA[47: 25]).

At 916, data memory device 510 may check one or more protection bits associated with the set and way at which the portion of the physical address is stored to ensure that the page located at physical address is accessible by processor 502 (e.g., data memory device 510 may determine that the read protection bit is set). If processor 502 is enabled to access the page, then the portion of the physical address (e.g., PA[47: 25]) is provided to address generator 522, which concatenates the portion of the physical address with a portion of the virtual address (e.g., the least significant 25 bits (VA[24: 0])). Address generator 522 may return the concatenated address to processor 502, which retrieves the page from the concatenated address.

At 918, miss handler 520 may perform a table walk on page table 516. For example, miss handler 520 may be configured to obtain the physical address corresponding to the virtual address indicated by the translation request from page table 516.

At 920, miss handler 520 may replace a physical address stored in a particular way in data memory device 510 with the physical address returned from page table 516.

At 922, miss handler 520 may determine whether the page located at the physical address is 16 KB or 32 MB based on the physical address. For example, if the physical address returned from page table 516 is 34 bits (PA[47: 14]), then miss handler 520 determines that the page size is 16 KB, and method 900 continues to 912. If the physical address returned from page table 516 is 23 bits (PA[47: 25]), then miss handler 520 determines that the page size is 32MB, and method 900 continues to operation 916. In another example, each page table entry of page table 516 may include an indication (e.g., a leaf bit) that indicates whether the page size is 16 KB or 32 MB (e.g., a value of “0” may indicate a first page size (e.g., 16 KB) and a value of “1” may indicate a second page size (e.g., 32 MB)).

Referring again to FIG. 5, in an example in which first tag memory device 506 is configured to store virtual addresses for 16 KB pages, second tag memory device 508 is configured to store virtual address for 32 MB, and data memory device 510 is configured to store two page table entries per way, the first lookup request may indicate 25 address bits of the virtual address (e.g., the 25 most significant bits of the virtual address (e.g., VA[39: 15])), and the second lookup request may indicate 14 address bits of the virtual address (e.g., the 14 most significant bits of the virtual address (e.g., VA[39: 26])). In an embodiment in which first tag memory device 506 includes four sets, first tag memory device 506 may utilize a first portion of the virtual address (e.g., the least two most significant bits (VA[16: 15])) to select a set from the four different sets, and the tag portion of the virtual address cached in first tag memory device 506 may correspond to the 13 most significant bits of the virtual address (e.g., VA[39: 17]). In an embodiment in which second tag memory device 508 includes four sets, second tag memory device 508 may utilize a first portion of the virtual address (e.g., the least two most significant bits (VA[27: 26])) to select a set from the four different sets, and the tag portion of the virtual address cached in second data memory device 510 may correspond to the 12 most significant bits of the virtual address (e.g., VA[39: 28]).

To select a page table entry from a particular way of data memory device 510 to obtain a cached physical address, a particular address bit of the virtual address may be utilized (e.g., VA[14] if the page is 16 KB or VA[25] if the page is 32 MB).

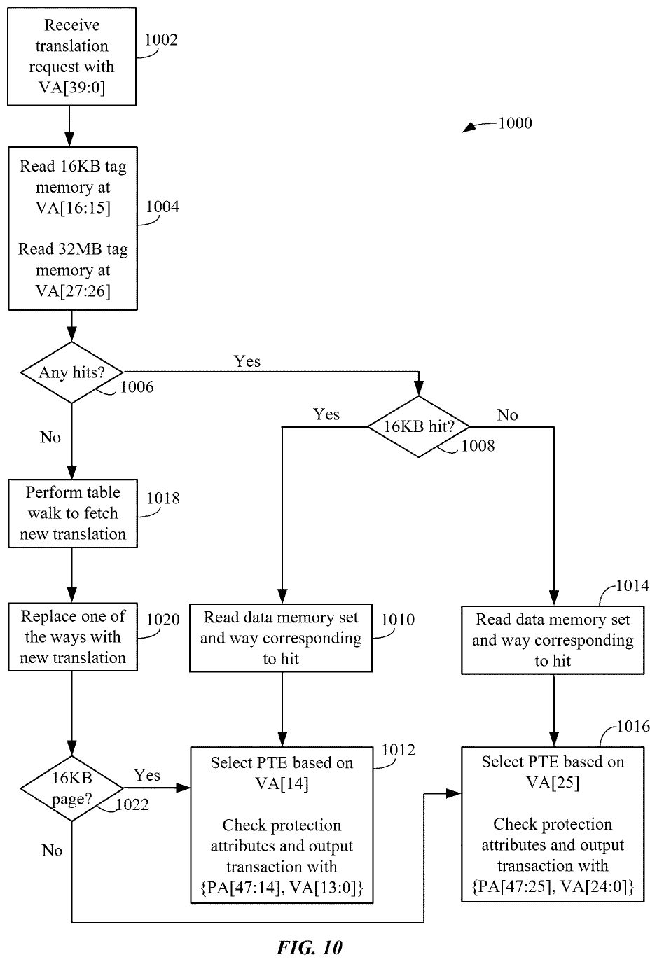

FIG. 10 is a flowchart for a method for performing a virtual-to-physical address translation based on a data memory configured to store two page table entries per way, according to some embodiments. Method 1000 can be performed by processing logic that can include hardware (e.g., circuitry, dedicated logic, programmable logic, or microcode), software (e.g., instructions executing on a processing device), or a combination thereof. It is to be appreciated that not all steps may be needed to perform the disclosure provided herein. Further, some of the steps may be performed simultaneously, or in a different order than shown in FIG. 10, as will be understood by a person of ordinary skill in the art. Method 1000 shall be described with reference to FIG. 5. In particular, method 1000 shall be described in an example in which virtual addresses are 40 bits, physical addresses are 48 bits, first tag memory device 506 is configured to store portions of virtual addresses for 16 KB pages (e.g., the 23 most significant bits (VA[39: 17])), second tag memory device 508 is configured to store portions of virtual addresses for 32 MB pages (e.g., the 12 most significant bits [39: 28]), and data memory device 510 is configured to store two page table entries per way. Method 1000 is not limited to those examples.

At 1002, processor 502 may generate a translation request to translate a virtual address to a physical address. The translation request may indicate the 40-bit virtual address (e.g., VA[39: 0]) to be translated. The translation request is provided to and received by lookup request generator 518.

At 1004, lookup request generator 518 may read first tag memory device 506 at a set indicated by virtual address bits [16: 15] to determine whether the virtual address is stored in first tag memory device 506. For example, lookup request generator 518 may generate a first lookup request including virtual address bits [39: 15]). First tag memory device 506 may be configured to determine whether the virtual address indicated by the first lookup request is stored in one of the ways of the set of first tag memory device 506 indicated by bits [16: 15], and if so, whether the valid bit associated with the set and way in which virtual address is stored is set. Lookup request generator 518 may also read second tag memory device 508 at a set indicated by virtual address bits [27: 26] to determine whether the virtual address is stored in second tag memory device 508. For example, lookup request generator 518 may generate a second lookup request including virtual address bits [39: 26]). Second tag memory device 508 may be configured to determine whether the virtual address indicated by the second lookup request is stored in one of the ways of the set of second tag memory device 508 indicated by bits [27: 26], and if so, whether the valid bit associated with the set and way in which virtual address is stored is set.

At 1006, lookup request generator 518 may determine whether a tag memory hit occurred with respect one of first tag memory device 506 or second tag memory device 508. For example, lookup request generator 518 may determine whether first tag memory device 506 or second tag memory device 508 returned an indication that the virtual address is stored in first tag memory device 506 or second tag memory device 508, respectively. In response to determining that one of first tag memory device 506 or second tag memory device 508 returned such an indication, method 1000 continues to operation 1008. Otherwise, method 1000 continues to operation 1018.

At 1008, lookup request generator 518 may determine whether a hit occurred with respect to first tag memory device 506 or second tag memory device 508. For example, if first tag memory device 506 provides an indication that the virtual address is stored therein, lookup request generator 518 determines that a hit occurred with respect to first tag memory device 506, and method 1000 continues to operation 1010. If second tag memory device 508 provides an indication that the virtual address is stored therein, lookup request generator 518 determines that a hit occurred with respect to second tag memory device 508, and method 1000 continues to operation 1014.

At 1010, data memory device 510 is read at a location corresponding to the set and way at which the virtual address is stored in first tag memory device 506 to obtain a portion of the physical address stored at that set and way (e.g., PA[47: 14]).

At 1012, data memory device 510 may check one or more protection bits associated with a particular page table entry (e.g., determined based on VA[14]) of the set and way at which the portion of the physical address is stored to ensure that the page located at physical address is accessible by processor 502 (e.g., data memory device 510 may determine that the read protection bit is set). If processor 502 is enabled to access the page, then the portion of the physical address (e.g., PA[47: 14]) is provided to address generator 522, which concatenates the portion of the physical address with a portion of the virtual address (e.g., the least significant 14 bits (VA[13: 0])). Address generator 522 may return the concatenated address to processor 502, which retrieves the page from the concatenated address.

At 1014, data memory device 510 is read at a location corresponding to the set and way at which the virtual address is stored in second tag memory device 508 to obtain a portion of the physical address stored at that set and way (e.g., PA[47: 25]).

At 1016, data memory device 510 may check one or more protection bits associated with a particular page table entry (e.g., determined based on VA[25]) of the set and way at which the portion of the physical address is stored to ensure that the page located at physical address is accessible by processor 502 (e.g., data memory device 510 may determine that the read protection bit is set). If processor 502 is enabled to access the page, then the portion of the physical address (e.g., PA[47: 25]) is provided to address generator 522, which concatenates the portion of the physical address with a portion of the virtual address (e.g., the least significant 25 bits (VA[24: 0])). Address generator 522 may return the concatenated address to processor 502, which retrieves the page from the concatenated address.

At 1018, miss handler 520 may perform a table walk on page table 516. For example, miss handler 520 may be configured to obtain the physical address corresponding to the virtual address indicated by the translation request from page table 516.

At 1020, miss handler 520 may replace a physical address stored in a particular page table entry of a particular way in data memory device 510 with the physical address returned from page table 516.

At 1022, miss handler 520 may determine whether the page located at the physical address is 16 KB or 32 MB based on the physical address. For example, if the physical address returned from page table 516 is 34 bits (PA[47: 14]), then miss handler 520 determines that the page size is 16 KB, and method 1000 continues to 1012. If the physical address returned from page table 516 is 23 bits (PA[47: 25]), then miss handler 520 determines that the page size is 32 MB, and method 1000 continues to operation 1016. In another example, each page table entry of page table 516 may include an indication (e.g., a leaf bit) that indicates whether the page size is 16 KB or 32 MB (e.g., a value of “0” may indicate a first page size (e.g., 16 KB) and a value of “1” may indicate a second page size (e.g., 32 MB)).

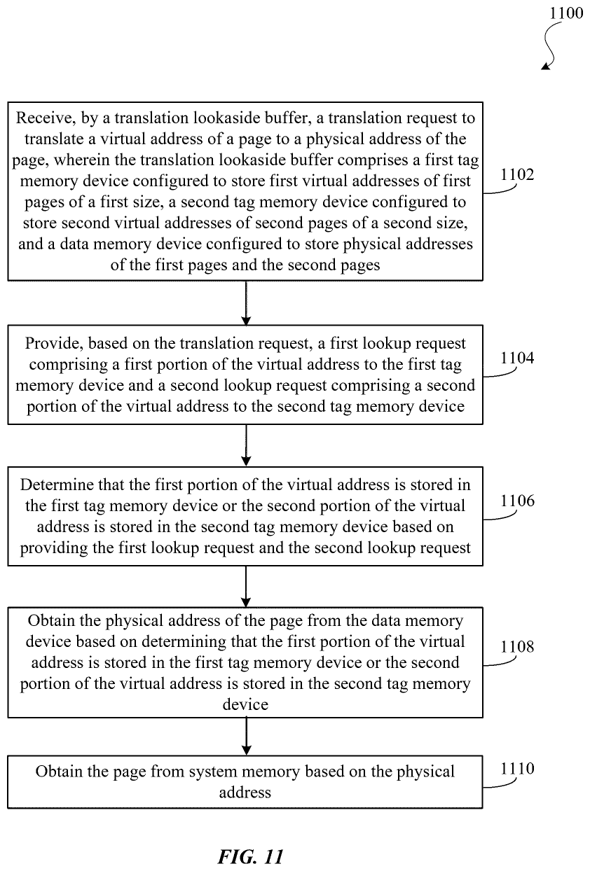

FIG. 11 is a flowchart for a method 1100 for performing virtual-to-physical address translations, according to some embodiments. Method 1100 can be performed by processing logic that can include hardware (e.g., circuitry, dedicated logic, programmable logic, or microcode), software (e.g., instructions executing on a processing device), or a combination thereof. It is to be appreciated that not all steps may be needed to perform the disclosure provided herein. Further, some of the steps may be performed simultaneously, or in a different order than shown in FIG. 11, as will be understood by a person of ordinary skill in the art.

Method 1100 shall be described with reference to FIG. 5. Method 1100 is not limited to those examples.

In 1102, TLB 504 may receive a translation request to translate a virtual address of a page (e.g., a page from page(s) 512 or page(s) 514) to a physical address of the page. TLB 504 may include first tag memory device 506 configured to store first virtual addresses of first pages of a first size, second tag memory device 508 configured to store second virtual addresses of second pages of a second size, and data memory device 510 configured to store physical addresses of the first pages and the second pages. The translation request may be generated by processor 502 and received by lookup request generator 518 of TLB 504.

In 1104, lookup request generator 518 of TLB 504 may provide, based on the translation request, a first lookup request including a first portion of the virtual address to first tag memory device 506 and a second lookup request including a second portion of the virtual address to second tag memory device 508. In some embodiments, the first lookup request is provided to the tag memory device 506 in parallel to providing the second lookup request to second tag memory device 508.

In some embodiments, first tag memory device 506 is a first set-associative memory including first sets, where each of the sets includes at least one first way, and second tag memory device 508 is a second set-associative memory including second sets, where each of the second sets includes at least one second way. For example, as shown in FIGS. 6 and 7, each of tag memory devices 600 and 700 include four sets, each including two ways.

In some embodiments, the data memory device 510 is a set-associative memory including sets, where each of the sets includes at least one first way, and each way of the at least one first way of each set of the sets stores a respective physical address. For example, as shown in FIGS. 8A and 8B, data memory devices 800A and 800B include entries, each corresponding to a particular set and way of first tag memory device 600 or second tag memory device 700. Data memory device 800A stores one physical address per way, and data memory device 800B stores two physical addresses per way.

In an example in which data memory device 510 is configured to store one page table entry per way, the first portion of the virtual address may include the 24 most significant bits of the virtual address (e.g., VA[39: 16]), and the second portion of the virtual address may include the 13 most significant bits of the virtual address (e.g., VA[39: 27]). In an example in which data memory device 510 is configured to store page tables entries per way (e.g., two page table entries per way), the first portion of the virtual address may include the 23 most significant bits of the virtual address (e.g., VA[39: 17]), and the second portion of the virtual address may include the 12 most significant bits of the virtual address (e.g., VA[39: 28]).

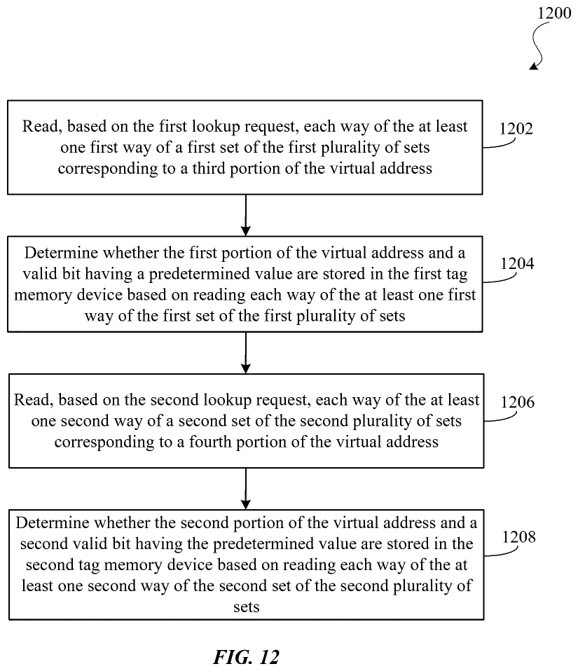

In 1106, lookup request generator 518 may determine that the first portion of the virtual address is stored in first tag memory device 506 or the second portion of the virtual address is stored in second tag memory device 508 based on providing the first lookup request and the second lookup request. For example, either first tag memory device 506 may provide an indication to lookup request generator 518 that indicates that the first portion of the virtual address is cached in first tag memory device 506 or second tag memory device 508 may provide an indication to lookup request generator 518 that indicates that the second portion of the virtual address is cached in second tag memory device 508. Additional details regarding determining that the first portion of the virtual address is stored in first tag memory device 506 or the second portion of the virtual address is stored in second tag memory device 508 are provided below with reference to FIG. 12.

In 1108, address generator 522 may obtain the physical address of the page from data memory device 510 based on determining that the first portion of the virtual address is stored in first tag memory device 506 or the second portion of the virtual address is stored in second tag memory device 508.

In some embodiments, obtaining the physical address for the page from data memory device 510 includes determining that the first portion of the virtual address is stored in first tag memory device 506 and obtaining the physical address from a location of data memory device 510 corresponding to a way of the at least one first way of the first set. For example, lookup request generator 518 may determine that the first portion of the virtual address is stored in first tag memory device 506 based on receiving an indication (e.g., a tag memory hit indication) from first tag memory device 506. The indication may indicate the set and way of first tag memory device 506 in which the first portion of the virtual address is stored. Address generator 522 may obtain the physical address from a location of data memory device 510 corresponding to the set and way of first tag memory device 506 in which the first portion of the virtual address is stored. If the page is a 16KB page, address generator 522 may concatenate a portion of the obtained physical address (e.g., the most significant 34 bits (PA[47: 14])) with a portion of the virtual address (e.g., the least significant 14 bits (VA[13: 0])). Address generator 522 may return the concatenated address to processor 502.

In some embodiments, obtaining the physical address for the page from data memory device 510 includes determining that the second portion of the virtual address is stored in second tag memory device 508 and obtaining the physical address from a location of data memory device 510 corresponding to a way of the at least one second way of the second set. For example, lookup request generator 518 may determine that the second portion of the virtual address is stored in second tag memory device 508 based on receiving an indication (e.g., a tag memory hit indication) from second tag memory device 508. The indication may indicate the set and way of second tag memory device 508 in which the second portion of the virtual address is stored. Address generator 522 may obtain the physical address from a location of data memory device 510 corresponding to the set and way of second tag memory device 508 in which the second portion of the virtual address is stored. If the page is a 32 MB page, address generator 522 may concatenate a portion of the obtained physical address (e.g., the most significant 23 bits (PA[47: 25])) with a portion of the virtual address (e.g., the least significant 25 bits (VA[24: 0])). Address generator 522 may return the concatenated address to processor 502.

In 1110, processor 502 may obtain the page from system memory 230 based on the physical address. For example, processor 502 may issue a read request to system memory 230 based on the concatenated address provided by address generator 522.

FIG. 12 is a flowchart for a method 1200 for determining that a portion of a virtual address is stored in a first tag memory device or a second tag memory device, according to some embodiments. Method 1200 can be performed by processing logic that can include hardware (e.g., circuitry, dedicated logic, programmable logic, or microcode), software (e.g., instructions executing on a processing device), or a combination thereof. It is to be appreciated that not all steps may be needed to perform the disclosure provided herein. Further, some of the steps may be performed simultaneously, or in a different order than shown in FIG. 12, as will be understood by a person of ordinary skill in the art.

Method 1200 shall be described with reference to FIG. 5. Method 1200 is not limited to those examples.

In 1202, first tag memory device 506 may read, based on the first lookup request, each way of the at least one first way of a first set of the first sets corresponding to a third portion of the virtual address. In an example in which first tag memory device 506 caches virtual addresses for 16 KB pages and data memory device 510 is configured to cache one page table entry per way, first tag memory device 506 may read each way of a set corresponding to VA[15: 14]. In an example in which first tag memory device 506 caches virtual addresses for 16 KB pages and data memory device 510 is configured to cache two page table entries per way, first tag memory device 506 may read each way of a set corresponding to VA[16: 15].

In 1204, first tag memory device 506 may determine whether the first portion of the virtual address and a valid bit having a predetermined value are stored in first tag memory device 506 based on reading each way of the at least one first way of the first set of the first sets based on the first lookup request. In an example in which first tag memory device 506 caches virtual addresses for 16 KB pages and data memory device 510 is configured to cache one page table entry per way, first tag memory device 506 may determine whether VA[39: 16] is cached in a way of a set corresponding VA[15: 14] and whether the associated valid bit (as shown in FIG. 6) is a predetermined value (e.g., set to a value of “1”). In an example in which first tag memory device 506 caches virtual addresses for 16 KB pages and data memory device 510 is configured to cache two page table entries per way, first tag memory device 506 may determine whether VA[39: 17] is cached in a way of a set corresponding VA[16: 15] and whether the associated valid bit (as shown in FIG. 6) is a predetermined value (e.g., set to a value of “1”).

In 1206, second tag memory device 508 may read, based on the second lookup request, each way of the at least one second way of a second set of the second sets corresponding to a fourth portion of the virtual address. In an example in which second tag memory device 508 caches virtual addresses for 32 MB pages and data memory device 510 is configured to cache one page table entry per way, second tag memory device 508 may read each way of a set corresponding to VA[26: 25]. In an example in which second tag memory device 508 caches virtual addresses for 32 MB pages and data memory device 510 is configured to cache two page table entries per way, second tag memory device 508 may read each way of a set corresponding to VA[27: 26].

In 1208, second tag memory device 508 may determine whether the second portion of the virtual address and a valid bit having a predetermined value are stored in second tag memory device 508 based on reading each way of the at least one second way of the second set of the second sets. In an example in which second tag memory device 508 caches virtual addresses for 32 MB pages and data memory device 510 is configured to cache one page table entry per way, second tag memory device 508 may determine whether VA[39: 27] is cached in a way of a set corresponding VA[26: 25] and whether the associated valid bit (as shown in FIG. 7) is a predetermined value (e.g., set to a value of “1”). In an example in which second tag memory device 508 caches virtual addresses for 32 MB pages and data memory device 510 is configured to cache two page table entries per way, second tag memory device 508 may determine whether VA[39: 28] is cached in a way of a set corresponding VA[27: 26] and whether the associated valid bit (as shown in FIG. 7) is a predetermined value (e.g., set to a value of “1”).

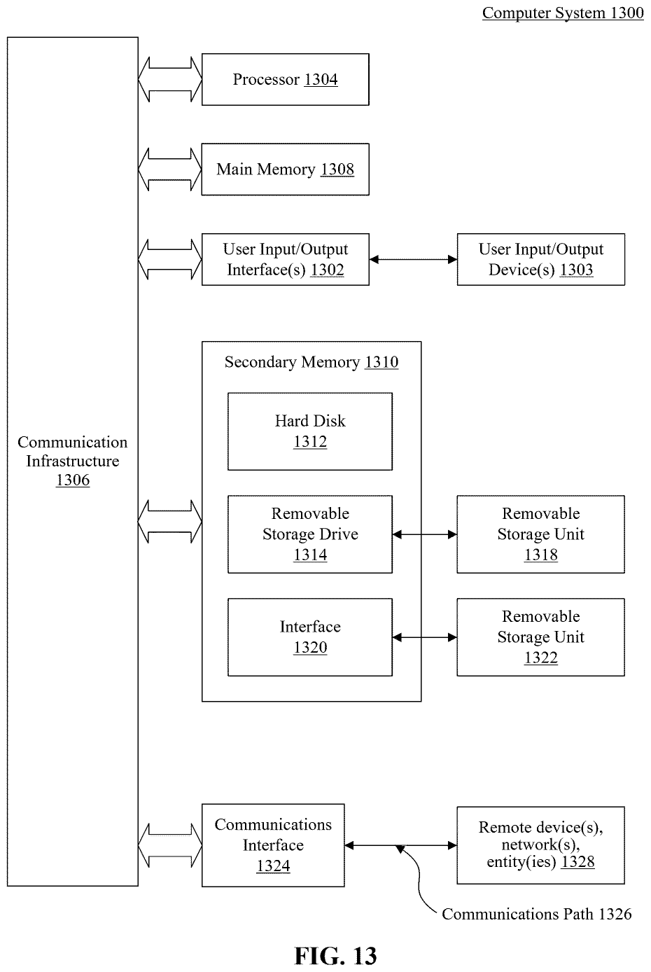

Various aspects can be implemented, for example, using one or more computer systems, such as computer system 1300 shown in FIG. 13. Computer system 1300 can be any computer capable of performing the functions described herein, such as the functions of device 100 of FIGS. 1 and 2 (and the components thereof), neural processor 218 of FIG. 2 (and the components thereof), neural engine 314 of FIGS. 3 and 4 (and the components thereof), system 500 (and the components thereof), and the operations of FIGS. 9-12. Computer system 1300 includes one or more processors (also called central processing units, or CPUs), such as a processor 1304. Processor 1304 is connected to a communication infrastructure 1306 (e.g., a bus). Computer system 1300 also includes user input/output device(s) 1303, such as monitors, keyboards, pointing devices, etc., that communicate with communication infrastructure 1306 through user input/output interface(s) 1302. Computer system 1300 also includes a main or primary memory 1308, such as random access memory (RAM). Main memory 1308 may include one or more levels of cache. Main memory 1308 has stored therein control logic (e.g., computer software) and/or data.

Computer system 1300 may also include one or more secondary storage devices or memory 1310. Secondary memory 1310 may include, for example, a hard disk drive 1312 and/or a removable storage device or drive 1314. Removable storage drive 1314 may be a floppy disk drive, a magnetic tape drive, a compact disk drive, an optical storage device, tape backup device, and/or any other storage device/drive.

Removable storage drive 1314 may interact with a removable storage unit 1318. Removable storage unit 1318 includes a computer usable or readable storage device having stored thereon computer software (control logic) and/or data. Removable storage unit 1318 may be a floppy disk, magnetic tape, compact disk, DVD, optical storage disk, and/or any other computer data storage device. Removable storage drive 1314 reads from and/or writes to removable storage unit 1318 in a well-known manner.

According to some aspects, secondary memory 1310 may include other means, instrumentalities or other approaches for allowing computer programs and/or other instructions and/or data to be accessed by computer system 1300. Such means, instrumentalities or other approaches may include, for example, a removable storage unit 1322 and an interface 1320. Examples of the removable storage unit 1322 and the interface 1320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1300 may further include a communication or network interface 1324. Communication interface 1324 enables computer system 1300 to communicate and interact with any combination of remote devices, remote networks, remote entities, etc. (individually and collectively referenced by reference number 1328). For example, communication interface 1324 may allow computer system 1300 to communicate with remote devices 1328 over communications path 1326, which may be wired and/or wireless, and which may include any combination of LANs, WANs, the Internet, etc. Control logic and/or data may be transmitted to and from computer system 1300 via communication path 1326.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 1300, main memory 1308, secondary memory 1310 and removable storage units 1318 and 1322, as well as tangible articles of manufacture embodying any combination of the foregoing. Such control logic, when executed by one or more data processing devices (such as computer system 1300), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 13. In particular, aspects may operate with software, hardware, and/or operating system implementations other than those described herein.

It is to be appreciated that the Detailed Description section, and not the Abstract of the Disclosure section, is intended to be used to interpret the claims. The Abstract of the Disclosure section may set forth one or more but not all possible aspects of the present disclosure as contemplated by the inventor(s), and thus, are not intended to limit the subjoined claims in any way.

Unless stated otherwise, the specific aspects are not intended to limit the scope of claims that are drafted based on this disclosure to the disclosed forms, even where only a single example is described with respect to a particular feature. The disclosed aspects are thus intended to be illustrative rather than restrictive, absent any statements to the contrary. The application is intended to cover such alternatives, modifications, and equivalents that would be apparent to a person skilled in the art having the benefit of this disclosure.

The foregoing disclosure outlines features of several aspects so that those skilled in the art may better understand the aspects of the present disclosure. Those skilled in the art will appreciate that they may readily use the present disclosure as a basis for designing or modifying other processes and structures for carrying out the same purposes and/or achieving the same advantages of the aspects introduced herein. Those skilled in the art will also realize that such equivalent constructions do not depart from the spirit and scope of the present disclosure, and that they may make various changes, substitutions, and alterations herein without departing from the spirit and scope of the present disclosure.

1. A system, comprising:
at least one processor configured to provide a translation request to translate a virtual address of a page to a physical address of the page; and
a translation lookaside buffer comprising:
a first tag memory device configured to store first virtual addresses of first pages of a first size;
a second tag memory device configured to store second virtual addresses of second pages of a second size; and
a data memory device configured to store physical addresses of the first pages and the second pages, wherein the translation lookaside buffer is configured to:
provide, based on the translation request, a first lookup request comprising a first portion of the virtual address to the first tag memory device and a second lookup request comprising a second portion of the virtual address to the second tag memory device;
determine that the first portion of the virtual address is stored in the first tag memory device or the second portion of the virtual address is stored in the second tag memory device based on provision of the first lookup request and the second lookup request;
obtain the physical address of the page from the data memory device based on a determination that the first portion of the virtual address is stored in the first tag memory device or the second portion of the virtual address is stored in the second tag memory device; and
provide the physical address to the at least one processor for retrieval of the page based on the physical address.

2. The system of claim 1, wherein the first tag memory device is a first set-associative memory comprising a first plurality of sets and each of the first plurality of sets comprises at least one first way, and wherein the second tag memory device is a second set-associative memory comprising a second plurality of sets and each of the second plurality of sets comprises at least one second way.

3. The system of claim 2, wherein, to determine that the first portion of the virtual address is stored in the first tag memory device or the second portion of the virtual address is stored in the second tag memory device based on provision of the first lookup request and the second lookup request, the translation lookaside buffer is configured to:
read, based on the first lookup request, each way of the at least one first way of a first set of the first plurality of sets corresponding to a third portion of the virtual address;
determine whether the first portion of the virtual address and a valid bit having a predetermined value are stored in the first tag memory device based on reading each way of the at least one first way of the first set of the first plurality of sets;
read, based on the second lookup request, each way of the at least one second way of a second set of the second plurality of sets corresponding to a fourth portion of the virtual address; and
determine whether the second portion of the virtual address and a second valid bit having the predetermined value are stored in the second tag memory device based on reading each way of the at least one second way of the second set of the second plurality of sets.

4. The system of claim 3, wherein, to obtain the physical address of the page from the data memory device, the translation lookaside buffer is configured to:
determine that the first portion of the virtual address is stored in the first tag memory device; and
obtain the physical address from a location of the data memory device corresponding to a way of the at least one first way of the first set.

5. The system of claim 3, wherein, to obtain the physical address of the page from the data memory device, the translation lookaside buffer is configured to:
determine that the second portion of the virtual address is stored in the second tag memory device; and
obtain the physical address from a location of the data memory device corresponding to a way of the at least one second way of the second set.

6. The system of claim 1, wherein the data memory device is a set-associative memory comprising a plurality of sets and each of the plurality of sets comprises at least one first way, and wherein each way of the at least one first way of each set of the plurality of sets stores a respective physical address.

7. The system of claim 1, wherein the translation lookaside buffer is configured to provide the first lookup request to the first tag memory device and provide the second lookup request to the second tag memory device in parallel.

8. A method, comprising:
receiving, by a translation lookaside buffer, a translation request to translate a virtual address of a page to a physical address of the page, wherein the translation lookaside buffer comprises a first tag memory device configured to store first virtual addresses of first pages of a first size, a second tag memory device configured to store second virtual addresses of second pages of a second size, and a data memory device configured to store physical addresses of the first pages and the second pages;
providing, based on the translation request, a first lookup request comprising a first portion of the virtual address to the first tag memory device and a second lookup request comprising a second portion of the virtual address to the second tag memory device;
determining that the first portion of the virtual address is stored in the first tag memory device or the second portion of the virtual address is stored in the second tag memory device based on providing the first lookup request and the second lookup request;
obtaining the physical address of the page from the data memory device based on determining that the first portion of the virtual address is stored in the first tag memory device or the second portion of the virtual address is stored in the second tag memory device; and
obtaining the page from system memory based on the physical address.

9. The method of claim 8, wherein the first tag memory device is a first set-associative memory comprising a first plurality of sets and each of the first plurality of sets comprises at least one first way, and wherein the second tag memory device is a second set-associative memory comprising a second plurality of sets and each of the second plurality of sets comprises at least one second way.

10. The method of claim 9, wherein determining that the first portion of the virtual address is stored in the first tag memory device or the second portion of the virtual address is stored in the second tag memory device based on providing the first lookup request and the second lookup request comprises:
reading, based on the first lookup request, each way of the at least one first way of a first set of the first plurality of sets corresponding to a third portion of the virtual address;
determining whether the first portion of the virtual address and a valid bit having a predetermined value are stored in the first tag memory device based on reading each way of the at least one first way of the first set of the first plurality of sets;
reading, based on the second lookup request, each way of the at least one second way of a second set of the second plurality of sets corresponding to a fourth portion of the virtual address; and
determining whether the second portion of the virtual address and a second valid bit having the predetermined value are stored in the second tag memory device based on reading each way of the at least one second way of the second set of the second plurality of sets.

11. The method of claim 10, wherein obtaining the physical address of the page from the data memory device comprises:
determining that the first portion of the virtual address is stored in the first tag memory device; and
obtaining the physical address from a location of the data memory device corresponding to a way of the at least one first way of the first set.

12. The method of claim 10, wherein obtaining the physical address of the page from the data memory device comprises:
determining that the second portion of the virtual address is stored in the second tag memory device; and
obtaining the physical address from a location of the data memory device corresponding to a way of the at least one second way of the second set.

13. The method of claim 8, wherein the data memory device is a set-associative memory comprising a plurality of sets and each of the plurality of sets comprises at least one first way, and wherein each way of the at least one first way of each set of the plurality of sets stores a respective physical address.

14. The method of claim 8, wherein the first lookup request is provided to the first tag memory device in parallel to providing the second lookup request to the second tag memory device.

15. A device, comprising:
a translation lookaside buffer comprising:
a first tag memory device configured to store first virtual addresses of first pages of a first size;
a second tag memory device configured to store second virtual addresses of second pages of a second size; and
a data memory device configured to store physical addresses of the first pages and the second pages, wherein the translation lookaside buffer is configured to:
receive a translation request to translate a virtual address of a page to a physical address of the page;
provide, based on the translation request, a first lookup request comprising a first portion of the virtual address to the first tag memory device and a second lookup request comprising a second portion of the virtual address to the second tag memory device;
determine that the first portion of the virtual address is stored in the first tag memory device or the second portion of the virtual address is stored in the second tag memory device based on provision of the first lookup request and the second lookup request;
obtain the physical address of the page from the data memory device based on a determination that the first portion of the virtual address is stored in the first tag memory device or the second portion of the virtual address is stored in the second tag memory device.

16. The device of claim 15, wherein the first tag memory device is a first set-associative memory comprising a first plurality of sets and each of the first plurality of sets comprises at least one first way, and wherein the second tag memory device is a second set-associative memory comprising a second plurality of sets and each of the second plurality of sets comprises at least one second way.

17. The device of claim 16, wherein, to determine that the first portion of the virtual address is stored in the first tag memory device or the second portion of the virtual address is stored in the second tag memory device based on provision of the first lookup request and the second lookup request, the translation lookaside buffer is configured to:
read, based on the first lookup request, each way of the at least one first way of a first set of the first plurality of sets corresponding to a third portion of the virtual address;
determine whether the first portion of the virtual address and a valid bit having a predetermined value are stored in the first tag memory device based on reading each way of the at least one first way of the first set of the first plurality of sets;
read, based on the second lookup request, each way of the at least one second way of a second set of the second plurality of sets corresponding to a fourth portion of the virtual address; and
determine whether the second portion of the virtual address and a second valid bit having the predetermined value are stored in the second tag memory device based on reading each way of the at least one second way of the second set of the second plurality of sets.

18. The device of claim 17, wherein, to obtain the physical address of the page from the data memory device, the translation lookaside buffer is configured to:
determine that the first portion of the virtual address is stored in the first tag memory device; and
obtain the physical address from a location of the data memory device corresponding to a way of the at least one first way of the first set.

19. The device of claim 17, wherein, to obtain the physical address of the page from the data memory device, the translation lookaside buffer is configured to:
determine that the second portion of the virtual address is stored in the second tag memory device; and
obtain the physical address from a location of the data memory device corresponding to a way of the at least one second way of the second set.

20. The device of claim 15, wherein the data memory device is a set-associative memory comprising a plurality of sets and each of the plurality of sets comprises at least one first way, and wherein each way of the at least one first way of each set of the plurality of sets stores a respective physical address.
